(19) United States
(12) Patent Application Publication
(10) Pub. No.: US 2026/0105629 A1
(43) Pub. Date: Apr. 16, 2026

(54) VEHICLE TOW BALL DETECTION METHOD AND SYSTEM

(71) Applicant: Continental Autonomous Mobility US, LLC, Auburn Hills, MI (US)

(72) Inventors: Eduardo Jose Ramirez Llanos, Rochester, MI (US); Miguel Alejandro Wence Mejia, Bloomfield Hills, MI (US); Angel Fernando Ceballos Espinoza, Santiago de Querétaro (MX)

(73) Assignee: Continental Autonomous Mobility US, LLC, Auburn Hills, MI (US)

(21) Appl. No.: 19/355,331

(22) Filed: Oct. 10, 2025

Related U.S. Application Data
(60) Provisional application No. 63/705,587, filed on Oct. 10, 2024.
(60) Provisional application No. 63/705,857, filed on Oct. 10, 2024.

(51) Int. Cl. G06T 7/73; B60D 1/36; B60W 60/00

(52) U.S. Cl. CPC G06T 7/73; B60D 1/36; B60W 60/001; B60W 2420/403; G06T 2207/20084; G06T 2207/30252

(57) ABSTRACT

A position of a tow ball of a tow vehicle is detected by: receiving an image from a rear camera and a size of the tow ball; identifying, a representation of the tow ball projected onto a camera plane of the rear camera; determining at least two rays each passing through a center of the rear camera; estimating an angle formed between the first and second rays; estimating a distance from the rear camera to a center of the tow ball based upon the estimated angle and the size of the tow ball; and determining a height of the tow ball based upon the estimated distance. A lookup table, with entries that each include at least one x-direction value, at least one y-direction value associated with a tow ball representation in the image and a height value corresponding to the tow ball representation, may also be used.

### TECHNICAL FIELD

This disclosure relates to a method and device for detecting the position of a tow ball of a tow vehicle for use, for example, during automated trailer hitching.

### BACKGROUND

Trailers are usually unpowered vehicles that are pulled by a powered tow vehicle. A trailer may be a utility trailer, a popup camper, a travel trailer, livestock trailer, flatbed trailer, enclosed car hauler, and boat trailer, among others. The tow vehicle may be a car, a crossover, a truck, a van, a sports-utility-vehicle (SUV), a recreational vehicle (RV), or any other vehicle configured to attach to the trailer and pull the trailer. The trailer may be attached to a powered vehicle using a trailer hitch. A receiver hitch mounts on the tow vehicle and connects to the trailer hitch to form a connection. The trailer hitch may be a ball and socket, a fifth wheel and gooseneck, or a trailer jack. Other attachment mechanisms may also be used.

Trailer-hitch operations include automating the tow-vehicle positioning to align with a trailer and providing automated steering assistance while backing up a tow vehicle. Such operations typically help drivers with the challenging and often frustrating task of connecting to and maneuvering a trailer. Automated trailer-hitching systems may take over the challenging process of reversing a vehicle to align its hitch with a trailer's coupler.

Existing trailer hitch assist systems often utilize measurements relating to the tow ball of the tow vehicle that are provided by the tow vehicle user. Because such measurements are potentially unreliable, the operation of an autonomous or semi-autonomous trailer hitching operation which utilizes the tow ball measurement may be less effective and may result in the tow vehicle tow ball and/or the trailer coupler being damaged. Recent advancements in sensor technology have led to improved safety systems for vehicles. As such, it is desirable to provide a system that is capable of identifying and calculating the position of a tow ball of a tow vehicle in real-time in order to allow the tow vehicle to safely and accurately autonomously or semi-autonomously maneuver towards the trailer for hitching thereto.

### BRIEF SUMMARY

In accordance with at least one embodiment, a position of a tow ball of a tow vehicle is detected by: receiving an image from a rear camera and a size of the tow ball; identifying, a representation of the tow ball projected onto a camera plane of the rear camera; determining at least two rays each passing through a center of the rear camera; estimating an angle formed between the first and second rays; estimating a distance from the rear camera to a center of the tow ball based upon the estimated angle and the size of the tow ball; and determining a height of the tow ball based upon the estimated distance. A lookup table, with entries that each include at least one x-direction value, at least one y-direction value associated with a tow ball representation in the image and a height value corresponding to the tow ball representation, may also be used.

### BRIEF DESCRIPTION OF THE DRAWINGS

FIG. 1 is a schematic top view of an exemplary tow vehicle positioned in front of trailer.

FIG. 2 is a schematic view of an exemplary tow vehicle having a tow ball position calculator according to an example embodiment.

FIG. 3 illustrates the geometry of the trailer tow ball visualized from a camera for carrying out operations of the tow ball position calculator.

FIG. 4 is a simplified view of the geometrical relationship between the rear camera center and portions of the imaged tow ball.

FIG. 5 is a flowchart illustrating for estimating the tow ball position according to an example embodiment.

FIG. 6 is a schematic view of an exemplary tow vehicle having a tow ball position calculator according to an example embodiment.

FIG. 7 illustrates the transformation of an image from a rear camera of the vehicle of FIG. 1.

FIG. 8 is a simplified view illustrating the generation of a lookup table according to an example embodiment.

FIG. 9 is a flowchart illustrating defining search regions of a transformed image according to an example embodiment.

FIG. 10 illustrates an aspect of a tow ball identification process according to an example embodiment.

FIG. 11 depicts an identified tow ball representation using the process of FIG. 10.

FIG. 12 illustrates determining the height of a tow ball and estimating its world position according to an example embodiment.

FIG. 13 is a flow chart showing operations of a tow ball calculator in accordance with one or more embodiments of the invention.

Like reference symbols in the various drawings indicate like elements.

### DETAILED DESCRIPTION

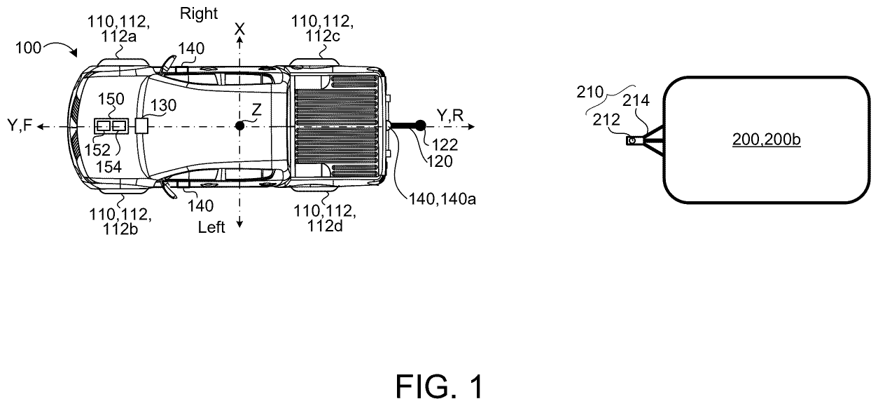

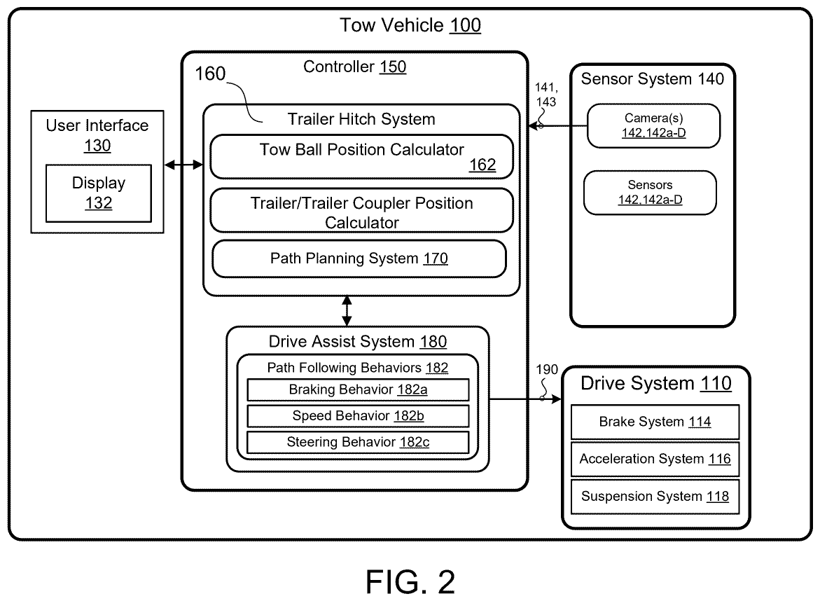

Referring to FIGS. 1 and 2, a tow vehicle 100, such as, but not limited to a car, a crossover, a truck, a van, a sports-utility-vehicle (SUV), and a recreational vehicle (RV) may be configured to hitch to and tow a trailer 200. The tow vehicle 100 connects to the trailer 200 by way of a tow vehicle hitch 120 having a tow vehicle tow ball 122 connecting to a trailer hitch 210 having a trailer coupler 212.

Referring to FIGS. 1-6, in some implementations, a driver of a tow vehicle 100 wants to tow a trailer 200 positioned behind the tow vehicle 100. In some examples, the driver maneuvers the tow vehicle 100 towards the trailer 200, while in other examples, the tow vehicle 100 autonomously drives towards the selected trailer 200. The tow vehicle 100 may include a drive system 110 that maneuvers the tow vehicle 100 across a road surface based on drive commands having x, y, and z components, for example. As shown, the drive system 110 includes a front right wheel 112, 112a, a front left wheel 112, 112b, a rear right wheel 112, 112c, and a rear left wheel 112, 112d. The drive system 110 may include other wheel configurations as well. The drive system 110 may also include a brake system 114 that includes brakes associated with each wheel 112, 112a-d, and an acceleration system 116 that is configured to adjust a speed and direction of the tow vehicle 100. In addition, the drive system 110 may include a suspension system 118 that includes tires associates with each wheel 112, 112a-d, tire air, springs, shock absorbers, and linkages that connect the tow vehicle 100 to its wheels 112, 112a-d and allows relative motion between the tow vehicle 100 and the wheels 112, 112a-d. The suspension system 118 may be configured to adjust a height of the tow vehicle 100 allowing a tow vehicle hitch 120 (e.g., a tow vehicle tow ball 122) to align with a trailer hitch 210 (e.g., trailer hitch coupler 212), which allows for autonomous connection between the tow vehicle 100 and the trailer 200.

The tow vehicle 100 may move across the road surface by various combinations of movements relative to three mutually perpendicular axes defined by the tow vehicle 100: a transverse axis X, a fore-aft axis Y, and a central vertical axis Z. The transverse axis X extends between a right side and a left side of the tow vehicle 100. A forward drive direction along the fore-aft axis Y is designated as F, also referred to as a forward motion. In addition, an aft or rearward drive direction along the fore-aft direction Y is designated as R, also referred to as rearward motion. When the suspension system 118 adjusts the suspension of the tow vehicle 100, the tow vehicle 100 may tilt about the X axis and or Y axis, or move along the central vertical axis Z.

The tow vehicle 100 may include a user interface 130. The user interface 130 receives one or more user commands from the driver via one or more input mechanisms or a screen display 132 (for examples, a touch screen display) and/or displays one or more notifications to the driver. The user interface 130 is in communication with a vehicle controller 150, which is in turn in communication with a sensor system 140. In some examples, the user interface 130 displays an image of an environment of the tow vehicle 100 leading to one or more commands being received by the user interface 130 (from the driver) that initiate execution of one or more behaviors. In some examples, the user display 132 displays a representation 136 of a trailer 200 positioned behind the tow vehicle 100. The vehicle controller 150 includes a computing device (or processor or data processing hardware) 152 (e.g., central processing unit having one or more computing processors) in communication with non-transitory memory 154 (e.g., a hard disk, flash memory, random-access memory, memory hardware) capable of storing instructions executable on the computing processor(s) 152.

The tow vehicle 100 may include a sensor system 140 to provide reliable and robust driving. The sensor system 140 may include different types of sensors that may be used separately or with one another to create a perception of the environment of the tow vehicle 100 that is used for the tow vehicle 100 to drive and aid the driver in make intelligent decisions based on objects and obstacles detected by the sensor system 140. The sensor system 140 may include the one or more cameras 142. In some implementations, the tow vehicle 100 includes a rear camera 142a that is mounted to provide images 143 of a rear view of the tow vehicle 100. The rear camera 142a may include a fisheye lens that includes an ultra wide-angle lens that produces strong visual distortion intended to create a wide panoramic or hemispherical image 143. Fisheye cameras capture images 143 having an extremely wide angle of view. Moreover, images 143 captured by the fisheye camera have a characteristic convex non-rectilinear appearance. Other types of cameras may also be used to capture images 143 of the rear-driving path of the tow vehicle 100.

The sensor system 140 may include other sensors such as, but not limited to, radar, sonar, LIDAR (Light Detection and Ranging, which can entail optical remote sensing that measures properties of scattered light to find range and/or other information of a distant target), LADAR (Laser Detection and Ranging), ultrasonic sensors, stereo cameras, etc.

The controller 150 may execute a tow ball position calculator algorithm or module 162 for determining the position of a tow ball 122 of a vehicle relative to a reference frame. The tow ball position calculator 162 may be associated with or otherwise part of a trailer hitch system 160 for autonomously or semi-autonomously maneuvering and positioning the tow ball of the tow vehicle 100 relative to the coupler of the trailer 200. The trailer hitch system 160 may include a number of modules and/or algorithms in carrying out various trailer hitching functions. Accurately determining the position of the tow ball 122 advantageously allows for precise positioning of the tow ball 122 relative to the trailer coupler 212 for more effectively performing a trailer hitching operation.

As mentioned, the trailer hitch system 160 may include other algorithms and/or modules for supporting trailer hitch functions. Each algorithm/module may include instructions which, when executed by the vehicle controller 150, causes the vehicle controller to perform one or more trailer hitch functions. For instance, trailer hitch system 160 may include an algorithm or module which detects and determines the position of the trailer coupler 212 (not shown in FIG. 2), and a path planning algorithm or module which determines a path for the tow vehicle 100 based at least in part upon the determined position of the vehicle tow ball 122 and the trailer coupler 212.

In an example embodiment, the tow ball position calculator 162 receives as input at least one image 143 from the rear camera 142a, and intrinsic and extrinsic parameters of the rear camera. The intrinsic and extrinsic parameters may include camera type, such as pinhole; image width and height; principle x- and y-axes; the focal length; the position (x, y, z) of the rear camera 142a relative to, for example, a center location along the rear axle of the tow vehicle 100; the center of the image array; and the rotation or orientation (yaw, pitch, and roll) of the rear camera. The parameters of the rear camera 142a may be maintained in memory 154 and retrieved by the vehicle controller 150 as needed. The tow ball position calculator 162 additionally receives as input a size of the tow ball 122. Tow balls are known to be in any of three possible common sizes-small, medium and large-such that the tow ball position calculator 152 receives as input one of the three sizes. The tow ball size may be provided by the tow vehicle operator via the user interface, or maintained in memory 154 and retrieved by the vehicle controller 150. With the captured rear camera image 143, the rear camera parameters and the size of the tow ball 142a, the tow ball position calculator 162 determines the position of the tow ball 142 (x, y, z) for subsequent use in, for example, carrying out one or more trailer hitch functions by the vehicle controller 150.

It is understood that the tow ball position calculator 162 may be configured based upon geographical region as to the common tow ball size(s) for that region. In this case, the tow ball position calculator 162 may be configured to accept in the U.S. a tow ball size from three common sizes and may be configured to accept one or more possible common sizes in another geographical region that are different from the common US sizes, such as Europe and/or one or more European countries. Further, the tow ball position calculator 162 may also receive as input a specific tow ball size provided by tow vehicle user or as retrieved from memory that does not correspond to a common size, which may find use in geographical regions in which there is no common size.

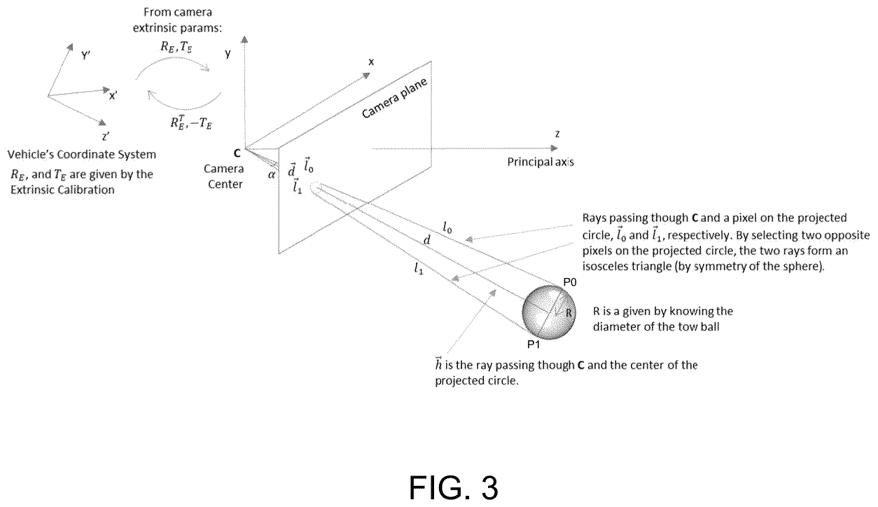

The operation of the tow ball position calculator 162 will be described with respect to FIGS. 3-5. The tow ball position calculator 162 may be activated as part of the activation of a trailer hitch function, such as a request to perform a trailer hitch assist operation. Once activated, the tow ball position calculator 162, and in particular the vehicle controller 150, receives one or more images captured by the rear camera 142a.

Next, the vehicle controller 150 receives at 504 intrinsic and extrinsic parameters of the rear camera 142a. These may be retrieved from memory 154 and/or provided from the tow vehicle user via the user interface 130. At 506, the vehicle controller 150, when executing the tow ball position calculator algorithm 162, identifies at 506 a representation of the tow ball 122 in the image(s) captured by the rear camera 142a. This step may be performed using any of a number of known approaches for detecting an object in image data. For example, the tow ball representation may be identified may utilize edge detection and/or contour analysis. Specifically, edge detection may be used to identify the boundary between the representation of the tow ball 122 and other objects in the image data. In an implementation, a Canny edge detection algorithm identifies the boundary of the tow ball 122. Further, a contour detection algorithm may be employed to find contours in the edge-detected image for locating the outer edge of the tow ball image representation. This may include selecting the contour that represents or best represents the interface or intersection between the tow ball 122 and other objects in the depicted scene in the image(s). In addition, a line or curve through the points in the image that are along the outer edge of the tow ball representation may be identified in identifying the tow ball 122.

Alternatively, the tow ball 122 may be detected using a texture and/or gradient based analysis. Specifically, the tow ball position calculator 162 may employ texture analysis using descriptors on the rear camera image(s). This analysis analyzes the texture differences between the representation of the tow ball 122 in the image and surrounding objects in the captured scene using texture descriptors, such as Local Binary Patterns (LBP). Differences in texture are used in distinguishing the tow ball representation from the representation of other objects in the image when color differences therebetween are negligible. Computing the magnitude and direction of an image gradient serves to identify areas of the image with substantial changes in intensity. The boundary between the tow ball 122 and surrounding objects may show distinct gradient patterns which may be used to identify representation of the tow ball 122. Peaks in the gradient magnitude along the tow ball boundary in the image data additionally or alternatively used to identify the tow ball representation in the captured rear camera image.

One or more example embodiments of the tow ball position calculator 162 may utilize a trained neural network and/or AI-generated model for use in identifying the tow ball representation in the captured rear camera image. The trained neural network and/or AI-generated model may utilize semantic segmentation and classification to identify the tow ball representation. One or more deep learning models may be trained specifically to segment the representation of the tow ball 122 from other objects appearing in the image. The deep learning model may have an architecture or framework such as, for example, Segformer, U-Net, Mask R-CNN (Region-based Convolutional Neural Network). After segmentation of the image, the trained neural network/model 156 extracts the tow ball representation from the generated segmentation mask to detect and/or identify the boundary of the tow ball representation.

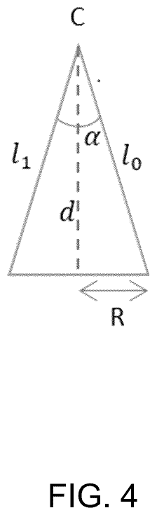

The vehicle controller 150, when executing the tow ball position calculator 162, estimates at 508 an angle α associated with the representation of the tow ball 122 in in the image/camera plane. Specifically, and with reference to FIG. 3, the spherical tow ball 122 is represented as a circle in the image captured by the rear camera 142a. The angle α is defined as the angle formed by the rays l₀ and l₁, each of which originates from the optical center C of the rear camera 142a and extends through a pixel along the circumference of the representation of the tow ball 122. In this case, the two pixels are disposed at opposite locations along the circumference of the tow ball representation so as to combine to form a diameter of the tow ball representation. The ray l₀ extends from optical center C to pixel P₀ along the outer edge of the representation of the tow ball 122, and ray l₁ extends from optical center C to pixel P₁ along the outer edge of the representation of the tow ball, where pixel P₀ and pixel P₁ together define the diameter of the tow ball representation in the image plane. Rays l₀ and l₁ combine with the tow ball diameter which extends between pixel P₀ and pixel P₁ to form an isosceles triangle T, as depicted in FIGS. 3 and 4, with angle α being opposite the side of the triangle T between pixels P₀ and P₁.

With the isosceles triangle T defined, the angle α may be determined based upon the following equation
which is derived from the equation
where (⋅) is the dot product between the two vectors of rays l₀ and l₁.

With the angle α determined, the vehicle controller 150 determines at 510 the distance d from center C of the rear camera 142a to the center of the tow ball 122. In particular, the distance d may be computed by

$$d = R / tan ( α / 2 ) ,$$

which is derived from the trigonometric relation

$$tan ( α / 2 ) = R / d ,$$

where R is the radius of the tow ball 122 which is known from the tow ball size provided as input as discussed above.

The vehicle controller 150 then determines at 512 the vector \vec{d}ₛ from the optical center C of the rear camera 142a to the closest surface point on the tow ball sphere. This vector is determined using the relationship
where \vec{d} is the vector or ray passing from the optical center C of the rear camera 142a to the projected circle at least partly defining the tow ball representation.

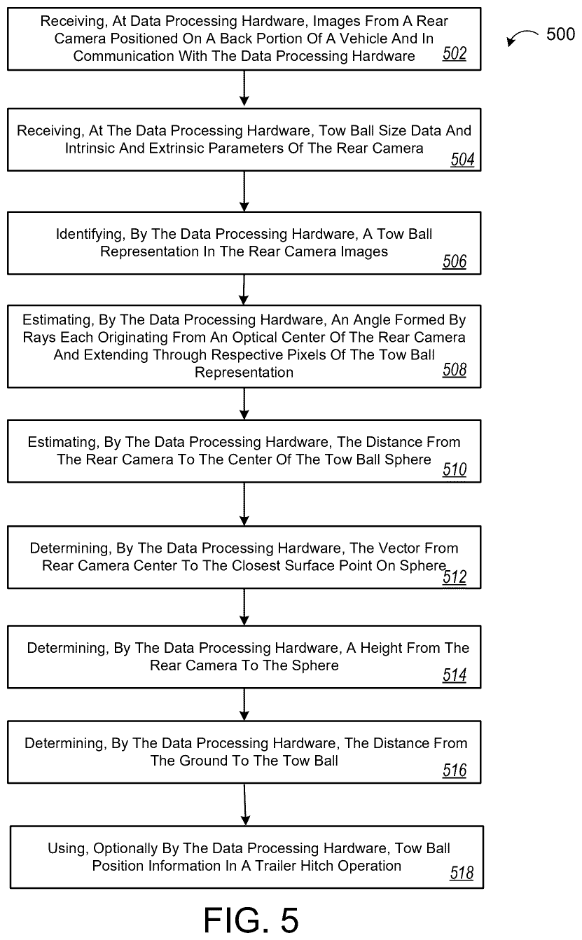

With continued reference to FIGS. 3 and 5, the height h from the rear camera 142a to tow ball sphere is determined at 514 as
where (⋅)_{z} is the z-component of the height vector and R_{E} is the rotation matrix to convert from the reference frame (coordinate system) of the tow vehicle 100 to the camera reference frame (coordinate system), which is provided with the above-discussed extrinsic parameters of the rear camera 142a. The term R_{E}^{T} is the transpose of the rotation matrix R_{E}.

Next, the distance from the ground surface to the tow ball 142a is estimated at 516 as

$${h}_{{}^{tow - ball}} = {h}_{c a m} - h ,$$

where h_{cam} is height of the rear camera 142a which is provided as input. Alternatively, the rear camera height h_{cam} can be estimated using a simultaneous localization and mapping (SLAM) algorithm or like algorithm. In the above equation, the height h is determined in block 514. This tow ball height h_{tow-ball} is understood to refer height of the center of the tow ball 122. It is understood that when the tow ball position calculator 162 is used with and/or as part of a trailer hitch assist system, block 516 is not needed because the height from the rear camera 142a to the tow ball 122 is used in an autonomous or semi-autonomous trailer hitching operation to ensure that the tow ball 122 does not, for example, collide with the coupler 212 of the trailer 200.

It is noted that the method described above and illustrated in FIG. 5 may be used with any transformation to (or of) the image 143 such as scaling, rotation, top view visualization, etc. If any such transformation is utilized, it is understood that block 514 of FIG. 5 would include the corresponding transformation to determine the height h from the rear camera 142a to the tow ball 122.

The tow ball position calculator 162 described above utilizes two pixels of the tow ball representation in the camera plane. It is understood that using more than two pixels of the tow ball representation may be averaged (and/or any statistical data or method) to provide an estimate of the height h that is more robust.

The focal length of the rear camera 142a is discussed above as an intrinsic parameter of the camera. The focal length of vehicle cameras may be provided in units of pixels, which would need to be converted to, for example, millimeters (mm). Such conversion may be performed by multiplying the focal length in pixels by the width of the image 143 in pixels divided by the image width in millimeters.

In addition, the pixel positions of the tow ball representation may be converted to Cartesian coordinates (in millimeters, for example) in order to trace the rays discussed above. In one implementation, the size of a single pixel in the image 143 (in millimeters or microns) may be used.

Referring to FIGS. 1 and 6-10, in some implementations, the trailer hitch system 160 may include other algorithms and/or modules for supporting trailer hitch functions. Each algorithm/module may include instructions which, when executed by the vehicle controller 150, cause the vehicle controller to perform one or more trailer hitch functions. For instance, trailer hitch system 160 may include a trailer/trailer coupler algorithm or module which detects and determines the position of the trailer/trailer coupler 212, and a path planning algorithm or module which determines a path for the tow vehicle 100 based at least in part upon the determined position of the vehicle tow ball 122 and the trailer coupler 212.

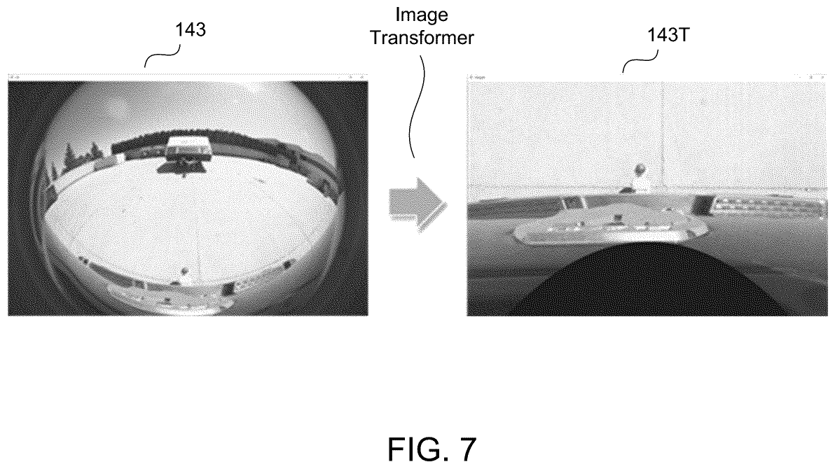

In accordance with at least one embodiment, the tow ball position calculator 162 includes a plurality of algorithms or modules which, when executed by the vehicle controller 150, provides position information of the tow ball 122 of the tow vehicle 100 relative to the reference frame of the rear camera 142a or the tow vehicle 100. In at least one example embodiment, the tow ball position calculator 162 includes an image transformer algorithm or module 164 which transforms and/or rectifies the image 143 captured by the rear camera 142a. This results in creating a virtual linear rear camera which is facing a downward direction towards the ground. In particular, the transformation provides linearity between the focal point of the rear camera 142a to the tow ball 122 such that when the tow ball 122 is moved up and down, the linearity is maintained. Each pixel in the rear camera image 143 is rotated in appearing in the transformed image 143T. The transformed image having a top view provides for the movement of the tow ball 122 to have a more linear behavior, relative to the image 143 captured by the rear camera 142a. FIG. 7 illustrates on the left an input image 143 captured by the rear camera 142a and on the right a transformed/rectified image 143T. Images 143 of different tow balls 122 are provided to the image transformer 164 for transforming/rectifying each image.

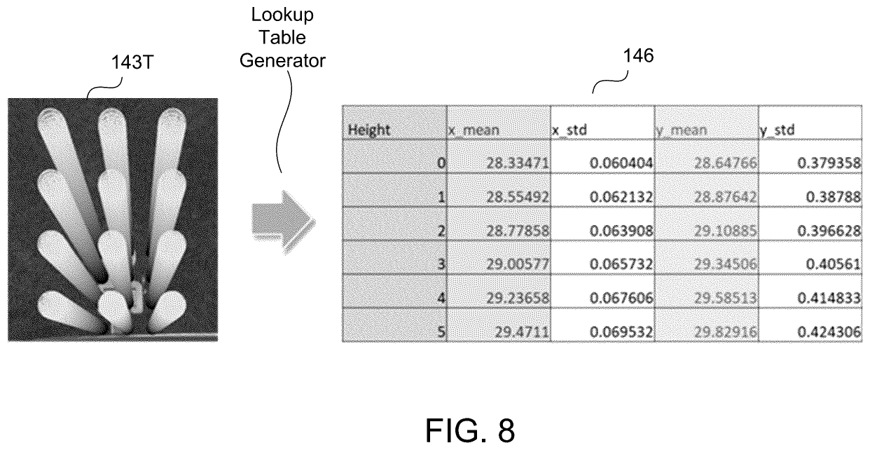

The transformed/rectified images 143T that are output by the image transformer 164 are provided to a lookup table generator algorithm or module 166. The lookup table generator 166 creates a lookup table 146 from the transformed images 143T. The lookup table 146 has an entry for each tow ball 122 which can possibly be used by the tow vehicle 100. Each entry of the lookup table 146 includes size information in pixels for the corresponding tow ball 122, including dimension information in the x-direction (mean and standard deviation) and y-direction (mean and standard deviation), and height information from the center of the tow ball 122 relative to the reference frame of the rear camera 142a and/or the tow vehicle 100. Based on the geometric properties of the linear space and the tow ball shape (a sphere), the system projects grids for each height level within limits, the pixel mean and standard deviation with respect to the width and length are determined. Whereas the data in second through fifth columns of the lookup table 146, illustrated in FIG. 8, is in units of pixels, the height data in the first column of the table is in units of centimeters. The completed lookup table 146 is then stored in memory 154 for use in determining the relative position of a tow ball 122 connected to the tow vehicle 100. FIG. 8 illustrates a transformed image 143T on the left that is provided to the lookup table generator 166 and on the right a sample lookup table having an entry, in this case arranged in a row, of dimensions associated with the corresponding tow ball. The image on the left in FIG. 8 shows a composite of a number of captured images 143T provided to the lookup table generator 166 in which each tow ball representation 122R has a different location in the image 143T and thus a different position (x, y) relative to the reference frame (rear camera 122 or tow vehicle 100). The lookup table generator 166 is able to determine the height (z) of the tow ball 122 relative to the rear camera 122 and/or the tow vehicle 100 based upon the position (x, y) of the tow ball representation 122R in the images 143T and upon the known diameter of the tow ball 122 (an extrinsic parameter provided to the system as discussed above), and include the determined tow ball height in the lookup table 146. By including, within limits, images with practically many possible positions (x, y) of the tow ball representation 122R in images 143T and/or a number of possible positions of the corresponding tow ball 122, and with including the known tow ball diameter, the lookup table 146 thus includes entries for a number of possible positions of the tow ball 122 (x, y) and its corresponding height (z) relative to the rear camera 122 and/or tow vehicle 100. Because of the transform performed by the image transformer 164 to generate the transformed images 143T which is provided as inputs to the lookup table generator 166, tow ball dimensions falling between the entries may be easily determined using linear extrapolation.

It is understood that the lookup table generator 166 may detect the tow ball representation 122R in the transformed images 143T using any of a number of different object detection algorithms as discussed below with respect to a tow ball identifier 168. Once generated, the lookup table 146 is available for use by the tow ball position calculator 162 in determining the position (x, y, z) of a tow ball 122 during each activation of the trailer hitch assist system 160. It is further understood that a separate lookup table may be utilized for each commonly size of the tow ball 122 (small, medium, large).

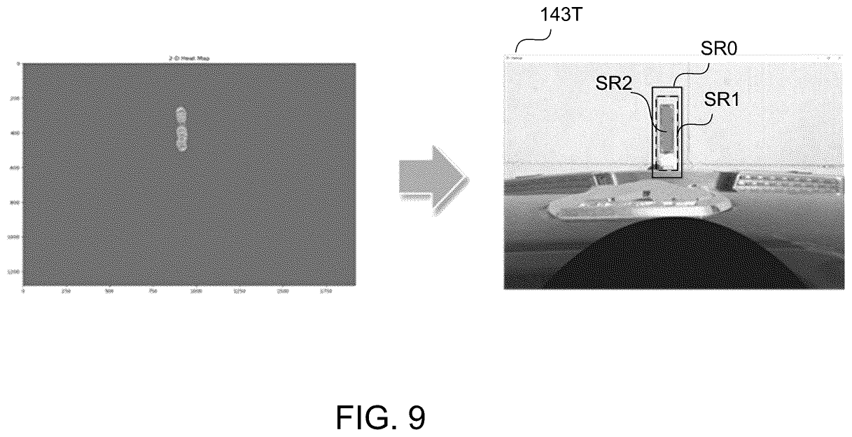

In at least one example embodiment, the tow ball position calculator 162 further includes the tow ball identifier algorithm or module 168 which receives an image 143T, captured by the rear camera 142a and transformed by the image transformer 164, and identifies the representation of the tow ball 122 in the transformed image 143T. The tow ball identifier 168 may define an initial search region SR0 within the transformed image 143T in order to search or scan for the tow ball representation. The initial search region SR0 is fixed with a predetermined size and location and is configured to cover both short and long tongue tow ball assemblies. Based upon the dataset available including the lookup tables 146 and the intrinsic and/or extrinsic parameters of the rear camera 142a discussed above, a search region SR1 within the initial search region SR0 is defined in which a tow ball representation 122R may appear. Following detection of a tow ball representation 122R in the search region SR1, and particularly the center of the tow ball representation 122R is detected, a subsequent search region SR2 is identified which contains the tow ball representation 122R. A first tow ball representation detection may be followed by a targeted, reverse and/or recursive detection may be used to improve and/or fine-tune the subsequent search region SR2. FIG. 9 illustrates a transformed image 143T having the initial search region SR0 and subsequent, fine-tuned regions SR1 and SR2. With subsequent search region SR2 identified, not only the center of the tow ball representation 122R is identified, but also points along the circumference of the tow ball representation 122R is identified, as described below.

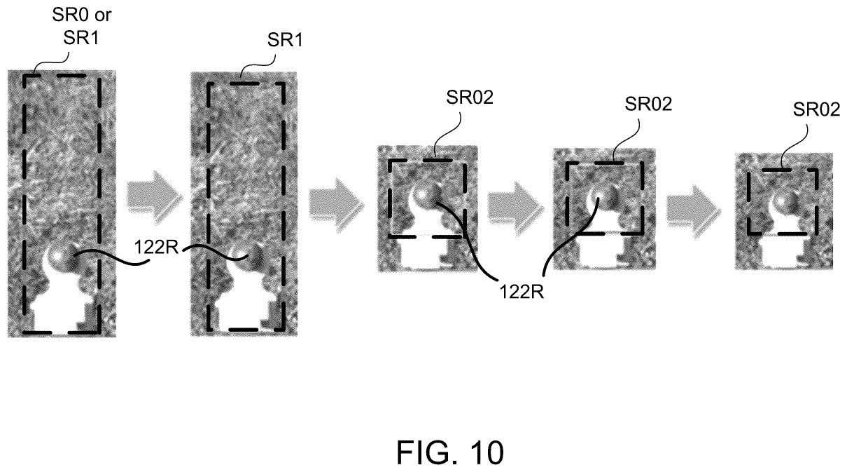

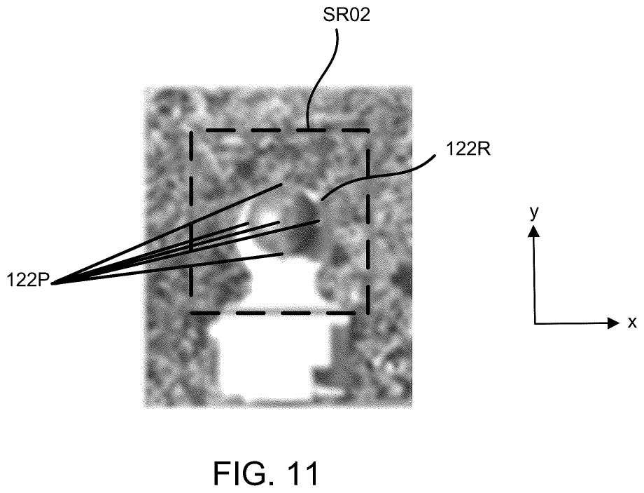

FIG. 10 illustrates a progression of tow ball identification process in which the initial search region SR0 is first defined, followed by the identification of the search region SR1 in response to an initial detection of the center of tow ball representation 122R, and further followed by the determination of the subsequent, more finely-tuned search region SR2 upon a targeted detection including the detection of a plurality of points 122P on the tow ball representation 122R. In one implementation depicted in FIG. 11, four points 122P are identified which may be equally disposed around the circumference of the tow ball representation 122R, with a fifth point 122P identified that is located at the center of the representation. It is understood that more or less points 122P may be utilized. The points 122P of the tow ball representation 122R are used to determine one or more dimensions, in pixels, of the tow ball representation 122R. The determined dimensions may include the diameter in the x-direction and/or the diameter in the y-direction.

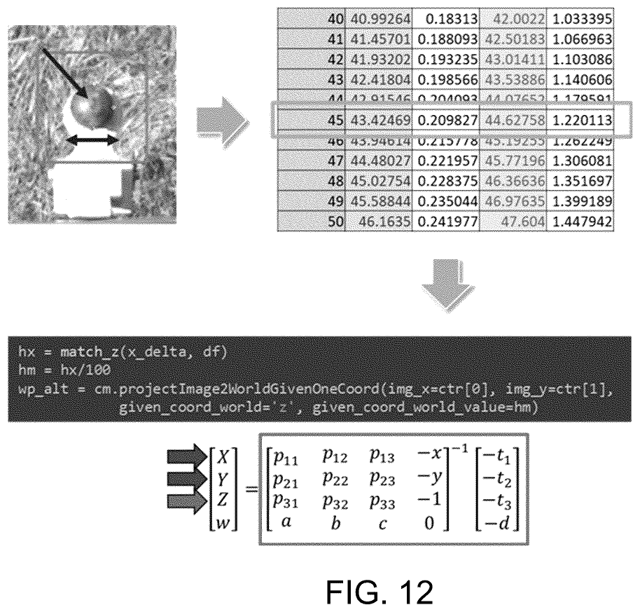

The determined dimension(s) of the tow ball representation 122R are used as inputs to the lookup table 146 to identify a corresponding height of the tow ball 122. The top part of FIG. 12 shows how the determined dimension(s) of the tow ball representation 122R are used to match the x-direction and y-direction values of the entries in the lookup table 146. The best matched dimension(s) of the tow ball representation, whether from selecting a single table entry or extrapolating dimensions between adjacent table entries, identifies the corresponding height of the tow ball representation 122R relative to a reference frame of the rear camera 142a or the tow vehicle 100.

The tow ball identifier 168 may identify the tow ball representation 122R of the tow ball 122 in the transformed image 143T using any of a number of object detection approaches. For example, the tow ball representation 122R may be identified utilizing edge detection and/or contour analysis. Specifically, edge detection may be used to identify the boundary between the representation 122R of the tow ball 122 and other objects in the image data. In an implementation, a Canny edge detection algorithm identifies the boundary of the tow ball representation 122R. Further, a contour detection algorithm may be employed to find contours in the edge-detected image for locating the outer edge of the tow ball image representation 122R. This may include selecting the contour that represents or best represents the interface or intersection between the tow ball representation 122R and other object representations in the depicted scene in the image(s). In addition, a line or curve through the points in the image 143T that are along the outer edge of the tow ball representation may be identified in identifying the tow ball representation 122R.

Alternatively, the tow ball 122 may be detected using a texture and/or gradient based analysis. Specifically, the tow ball position calculator 162 may employ texture analysis using descriptors on the rear camera image(s). This analysis analyzes the texture differences between the representation 122R of the tow ball 122 in the image and surrounding objects in the captured scene using texture descriptors, such as Local Binary Patterns (LBP). Differences in texture are used in distinguishing the tow ball representation 122R from the representation of other objects in the image when color differences therebetween are negligible. Computing the magnitude and direction of an image gradient serves to identify areas of the image with substantial changes in intensity. The boundary between the tow ball representation 122R and surrounding objects may show distinct gradient patterns which may be used to identify representation 122R of the tow ball 122. Peaks in the gradient magnitude along the tow ball boundary in the image data additionally or alternatively used to identify the tow ball representation 122R in the transformed rear camera image 143T.

One or more example embodiments of the tow ball position calculator 162 may utilize a trained neural network and/or an AI-generated model for use in identifying the tow ball representation 122R in the captured rear camera image. The trained neural network and/or AI-generated model may utilize semantic segmentation and classification to identify the tow ball representation. One or more deep learning models may be trained specifically to segment the representation 122R of the tow ball 122 from other objects appearing in the image. The deep learning model may have an architecture or framework such as, for example, Segformer, U-Net, Mask R-CNN (Region-based Convolutional Neural Network). After segmentation of the image, the trained neural network/model extracts the tow ball representation from the generated segmentation mask to detect and/or identify the boundary of the tow ball representation 122R.

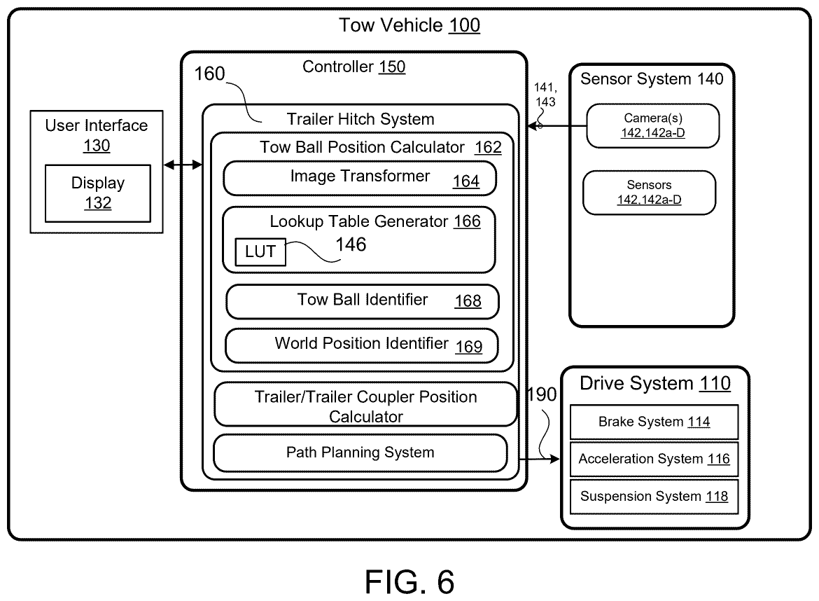

With continued reference to FIG. 6, the tow ball position calculator 162 further includes, in at least one implementation, a world position identifier algorithm or module 169. The world position identifier 169 determines the world position of the tow ball 122 by using an inverse transformation of the tow ball 122 (x, y) from two-dimension (2D) to three dimensions (3D) using the position information (x, y, z) determined from the matched lookup table entry.

The world position identifier 169 receives as input the height information of the tow ball 122, determined by the tow ball identifier 168, and a centroid of the tow ball 122. Whereas forward projection may be employed to transform a 3D point to a 2D image, the world position identifier 169 utilizes an inverse projection to transform a 2D image pixel to a 3D point in a plane. The equation for the plane that contains the projection of the 2D pixel may be seen as

$$a X + b Y + c Z + d = 0$$

Extending the projection of a 3D point to a 2D point in the camera's coordinate system to include the constraint of the projection plane results in

$$w [ \begin{matrix}x \\ y \\ 1 \\ 0\end{matrix} ] = [ \begin{matrix}{p}_{11} & {p}_{12} & {p}_{13} & 0 \\ {p}_{21} & {p}_{22} & {p}_{23} & 0 \\ {p}_{31} & {p}_{32} & {p}_{33} & 0 \\ a & b & c & d\end{matrix} ] [ \begin{matrix}X \\ Y \\ Z \\ 1\end{matrix} ] + [ \begin{matrix}{t}_{1} \\ {t}_{2} \\ {t}_{3} \\ 0\end{matrix} ]$$

Which is referred to as the forward projection of an arbitrary point to a pixel. In the above equation, pᵢⱼ is given by

$$K \cdot {}_{}^{c} {R}_{r}^{} = P = [ \begin{matrix}{p}_{11} & {p}_{12} & {p}_{13} \\ {p}_{21} & {p}_{22} & {p}_{23} \\ {p}_{31} & {p}_{32} & {p}_{33}\end{matrix} ] ,$$

Further, x, y are pixel coordinates, w is a scaling factor, K is the camera intrinsic parameter matrix; and R is the rotation matrix (from world coordinates to rear camera coordinates).
Solving for the 3D points X, Y, Z results in

$$[ \begin{matrix}X \\ Y \\ Z \\ w\end{matrix} ] = {[ \begin{matrix}{p}_{11} & {p}_{12} & {p}_{13} & - x \\ {p}_{21} & {p}_{22} & {p}_{23} & - y \\ {p}_{31} & {p}_{32} & {p}_{33} & - 1 \\ a & b & c & 0\end{matrix} ]}^{- 1} [ \begin{matrix}- {t}_{1} \\ - {t}_{2} \\ - {t}_{3} \\ - d\end{matrix} ]$$

which is the inverse projection equation shown in the bottom portion of FIG. 12. The points that form the largest circumference in the image from the projection of the tow ball sphere lie in a plane in the 3D world. Using this inverse projection equation above, the point (X, Y, Z, w) is solved based upon a number of terms being known, such as pᵢⱼ; tᵢ; d, which is the height value of the tow ball using the lookup table 146; (a, b, c) which is given by the normal vector of the camera plane, noting that the camera plane and the tow ball plane are parallel because the top-down transformation have the same normal vector.

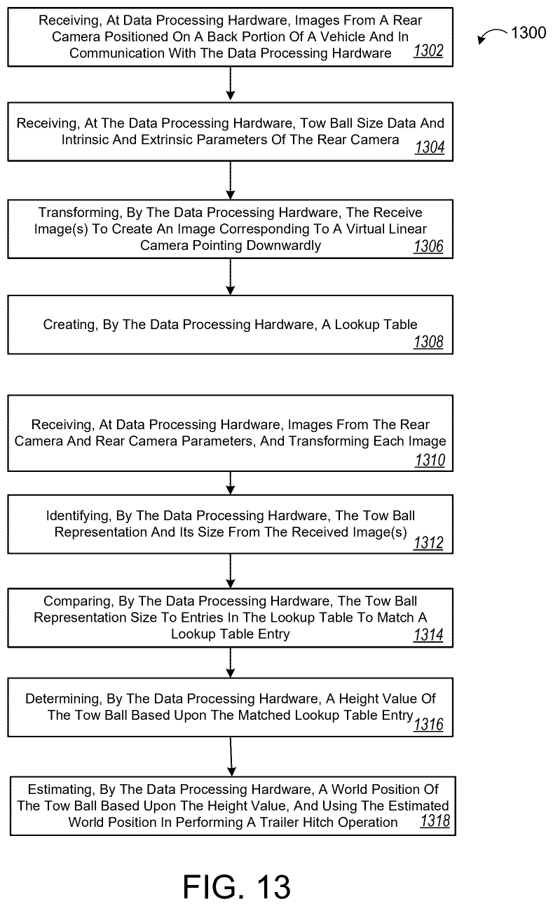

The operation 900 of the tow ball calculator 162 will be described with respect to FIG. 13. The tow ball position calculator 162 may be activated as part of the activation of a trailer hitch function, such as a request to perform a trailer hitch operation. Once activated, the tow ball position calculator 162, and in particular the vehicle controller 150 when executing the algorithm/modules thereof, receives at 902 one or more images 143 captured by the rear camera 142a. The vehicle controller 150 receives at 904 the above-discussed intrinsic and extrinsic parameters of the rear camera 142a. These may be retrieved from memory 154 and/or provided from the tow vehicle user via the user interface 130. At 906, the vehicle controller 150, and in particular the image transformer 164 when executed by the vehicle controller 150, performs a linear transform of one or more received images 143 captured by the rear camera 142a to generate a transformed image(s) 143T as described above. The transformed image(s) 143T are used with the tow ball size provided as input to create at 908 the lookup table 146 by the lookup table generator 166. Subsequent to the creation of the lookup table 146, a received image(s) 143 is transformed by the image transformer 164 at 910. At a tow ball representation 122R appearing in the transformed received image(s) 143T is identified at 912 by the tow ball identifier 168. The tow ball identifier 168 identifies at 912 the tow ball representation 122R, determines its size (x, y) at 914 and determines tow ball height at 916 relative to a reference frame (rear camera 142a or tow vehicle 100) by matching its determined size tow ball representation size to an entry in the created lookup table 146. The matched entry provides the height, measured in centimeters, of the tow ball 122. The world position of the tow ball height is then estimated at 918 by the world position identifier 169 to obtain a tow ball height which may be subsequently used in a trailer hitch operation. The position of the tow ball 122 relative to world coordinates may be subsequently used by the tow vehicle 100, such as in a trailer hitch operation to maneuver the tow vehicle 100 autonomously or semi-autonomously towards the trailer 200.

It is understood that the tow ball position calculator 162 may be configured based upon geographical region as to the common tow ball size(s) for that region. In this case, the tow ball position calculator 162 may be configured to accept in the U.S. a tow ball size from three common sizes, and may be configured to accept one or more possible common sizes in another geographical region that are different from the common US sizes, such as Europe and/or one or more European countries. Further, the tow ball position calculator 162 may also receive as input a specific tow ball size provided by tow vehicle user or as retrieved from memory that does not correspond to a common size, which may find use in geographical regions in which there is no common size.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus,” “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

In another embodiment, the tow ball position is determined using a geometric constraint that the tow hitch lies on the vehicle's latitudinal centerline (Y=0 plane). A ray is back-projected from the camera through the detected tow ball pixel, and its intersection with the Y=0 plane provides the 3D position (X, 0, Z) of the tow ball.

In yet another embodiment, the tow ball position is computed by intersecting a back-projected ray with a plane corresponding to the vehicle's latitudinal centerline.

1. A method of detecting a position of a tow ball of a tow vehicle, the method comprising:
receiving, at data processing hardware, an image from a rear camera positioned on a back portion of a vehicle and in communication with the data processing hardware;
receiving, at the data processing hardware, a size of a tow ball connected to the vehicle;
identifying, by the data processing hardware, a representation of the tow ball projected onto a camera plane of the rear camera;
determining, by the data processing hardware, at least two rays each originating from an optical center of the rear camera and extending through respective pixels of the tow ball representation;
estimating, by the data processing hardware, an angle formed between the first and second rays;
estimating, by the data processing hardware, a distance from the rear camera to a center of the tow ball based upon the estimated angle and the size of the tow ball;
determining, by the data processing hardware, a height of the tow ball based upon the estimated distance; and
using the determined tow ball height in a trailer hitch operation.

2. The method of claim 1, wherein the first and second pixels are opposite each other along a diameter of the tow ball representation such that the first and second rays form an isosceles triangle with a diameter of the tow ball representation that includes the first and second pixels.

3. The method of claim 1, wherein the determining of the rays and the estimating of the angle are based on intrinsic and extrinsic calibration parameters of the rear camera.

4. The method of claim 1, wherein the angle is estimated using more than two rays corresponding to multiple pixels along the circumference of the tow ball representation, and the estimated angle is an average of angles formed by the rays.

5. The method of claim 1, wherein identifying the representation of the tow ball comprises applying a trained neural network configured to perform semantic segmentation of the image.

6. The method of claim 1, further comprising estimating a height of the rear camera relative to a ground surface using a simultaneous localization and mapping (SLAM) algorithm.

7. The method of claim 1, further comprising compensating for lens distortion prior to determining the rays.

8. The method of claim 2, wherein the angle is estimated using an arccosine function based upon the first and second rays.

9. The method of claim 1, further comprising determining, by the data processing hardware, a vector from the center of the rear camera to a closest surface point of the tow ball based upon the estimated distance, wherein the determined height is based upon the determined vector.

10. A non-transitory computer readable medium having stored thereon computer-executable instructions that, when executed by at least one processor, cause detection of a position of a tow ball of a tow vehicle by performing operations comprising:
receiving, at data processing hardware, an image from a rear camera positioned on a back portion of a vehicle and in communication with the data processing hardware;
receiving, at the data processing hardware, a size of a tow ball connected to the vehicle;
identifying, by the data processing hardware, a representation of the tow ball projected onto a camera plane of the rear camera;
determining, by the data processing hardware, at least two rays each originating from an optical center of the rear camera and extending through respective pixels of the tow ball representation;
estimating, by the data processing hardware, an angle formed between the first and second rays;
estimating, by the data processing hardware, a distance from the rear camera to a center of the tow ball based upon the estimated angle and the size of the tow ball;
determining, by the data processing hardware, a height of the tow ball based upon the estimated distance; and
using the determined tow ball height in a trailer hitch operation.

11. The non-transitory computer readable medium of claim 5, wherein the first and second pixels are opposite each other along a diameter of the tow ball representation such that the first and second rays form an isosceles triangle with a diameter of the tow ball representation that includes the first and second pixels.

12. The non-transitory computer readable medium of claim 6, wherein the angle is estimated using an arccosine function based upon the first and second rays.

13. The non-transitory computer readable medium of claim 5, further comprising determining, by the data processing hardware, a vector from the center of the rear camera to a closest surface point of the tow ball based upon the estimated distance, wherein the determined height is based upon the determined vector.

14. A method of detecting and localizing a tow ball of a tow vehicle, the method comprising:
receiving, at data processing hardware, an image from a rear camera positioned on a back portion of a vehicle and in communication with the data processing hardware;
receiving, at the data processing hardware, a size of a tow ball connected to the vehicle;
receiving, at the data processing hardware, a lookup table having a plurality of entries, each lookup table entry including at least one x-direction value, at least one y-direction value associated with a tow ball representation in the image and a height value corresponding to the tow ball representation;
identifying, by the data processing hardware, a representation of the tow ball projected in the image of the rear camera, comprising: defining an initial search region and at least one subsequent search region that reduces a size of the initial search region, the identifying comprising identifying a plurality of points of tow ball representation appearing in the at least one subsequent search region, the plurality of points indicating a dimension of the tow ball;
estimating, by the data processing hardware, a height of the tow ball by matching the indicated dimension of the tow ball representation with a corresponding dimension value in the lookup table and extracting the height value associated with the corresponding dimension value; and
using the determined tow ball height value in a trailer hitch operation.

15. The method of claim 14, wherein generating the lookup table comprises projecting a plurality of synthetic tow ball images at different heights and positions using a camera model.

16. The method of claim 14, wherein estimating the height of the tow ball comprises interpolating between two or more entries of the lookup table.

17. The method of claim 14, wherein defining the at least one subsequent search region comprises dynamically adjusting the region based on a detected center of the tow ball representation.

18. The method of claim 14, wherein the lookup table includes entries for a plurality of tow ball sizes, and the method further comprises selecting a subset of entries based on the received tow ball size.

19. The method of claim 14, further comprising transforming the determined tow ball height and image coordinates into a world coordinate system using an inverse projection matrix.

20. The method of claim 14, further comprising:
transforming, by the data processing hardware, at least one second image from the rear camera by creating a virtual linear camera facing in a downward direction; and
generating the lookup table based upon the at least one transformed second image.

21. The method of claim 14, further comprising determining a world position of the tow ball based in part upon the tow ball height value.

22. A non-transitory computer readable medium having stored thereon computer-executable instructions that, when executed by at least one processor, cause detection and localization of a tow ball of a tow vehicle by performing operations comprising:
receiving, at data processing hardware, an image from a rear camera positioned on a back portion of a vehicle and in communication with the data processing hardware;
receiving, at the data processing hardware, a size of a tow ball connected to the vehicle;
receiving, at the data processing hardware, a lookup table having a plurality of entries, each lookup table entry including at least one x-direction value, at least one y-direction value associated with a tow ball representation in the image and a height value corresponding to the tow ball representation;
identifying, by the data processing hardware, a representation of the tow ball projected in the image of the rear camera, comprising: defining an initial search region and at least one subsequent search region that reduces a size of the initial search region, the identifying comprising identifying a plurality of points of tow ball representation appearing in the at least one subsequent search region, the plurality of points indicating a dimension of the tow ball;
estimating, by the data processing hardware, a height of the tow ball by matching the indicated dimension of the tow ball representation with a corresponding dimension value in the lookup table and extracting the height value associated with the corresponding dimension value; and
using the determined tow ball height value in a trailer hitch operation.

23. The non-transitory computer readable medium of claim 12, having stored thereon additional computer-executable instructions that, when executed by at least one processor, cause performance of further operations comprising:
transforming, by the data processing hardware, at least one second image from the rear camera by creating a virtual linear camera facing in a downward direction; and
generating the lookup table based upon the at least one transformed second image.

24. The non-transitory computer readable medium of claim 12, having stored thereon additional computer-executable instructions that, when executed by at least one processor, cause performance of further operations comprising determining a world position of the tow ball based in part upon the tow ball height value.

25. A method of determining a position of a tow ball of a tow vehicle, the method comprising:
receiving an image from a rear camera;
detecting a representation of the tow ball in the image;
back-projecting a ray from an optical center of the rear camera through a pixel corresponding to the tow ball representation; and
determining a 3D position of the tow ball by computing an intersection of the ray with a plane corresponding to a latitudinal centerline of the tow vehicle.

26. The method of claim 25, wherein the plane corresponds to Y=0 in a vehicle coordinate system.

27. The method of claim 25, wherein the rear camera has a lateral offset from the latitudinal centerline.

28. The method of claim 25, wherein the 3D position comprises X and Z coordinates of the tow ball and a fixed Y coordinate corresponding to the latitudinal centerline.

29. The method of claim 1, wherein using the determined tow ball height in a trailer hitch operation further comprises using the determined tow ball height in planning a path to autonomously maneuver the tow vehicle toward a trailer coupler.

30. The method of claim 14, wherein using the determined tow ball height in a trailer hitch operation further comprises using the determined tow ball height in planning a path to autonomously maneuver the tow vehicle toward a trailer coupler.

31. The method of claim 25, further comprising using the determined 3D position of the tow ball height in planning a path to autonomously maneuver the tow vehicle toward a trailer coupler.

32. The method of claim 1, further comprising fusing the determined tow ball height with at least one of an ultrasonic measurement or a radar measurement.

33. The method of claim 14, further comprising fusing the determined tow ball height with at least one of an ultrasonic measurement or a radar measurement.

34. The method of claim 25, further comprising fusing the determined 3D position of the tow ball height with at least one of an ultrasonic measurement or a radar measurement.
